(19) United States
(12) Patent Application Publication
(10) Pub. No.: US 2025/0173930 A1
(43) Pub. Date: May 29, 2025

(54) DATA CREATION DEVICE, DATA CREATION METHOD, AND PROGRAM

(71) Applicant: Sony Semiconductor Solutions Corporation, Kanagawa (JP)

(72) Inventors: Tomoki UEDA, Kanagawa (JP); Hiroshi ICHIKI, Kanagawa (JP); Masaki KASHIMORI, Kanagawa (JP)

(73) Assignee: Sony Semiconductor Solutions Corporation, Kanagawa (JP)

(21) Appl. No.: 18/842,816

(22) PCT Filed: Feb. 20, 2023
(86) PCT No.: PCT/JP2023/005919

§ 371 Date: Aug. 30, 2024

(30) Foreign Application Priority Data
Mar. 11, 2022 (JP) 2022-037743

(51) Int. Cl. G06T 11/60

(52) U.S. Cl. CPC G06T 11/60

(57) ABSTRACT

The present technology relates to a data creation device, a data creation method, and a program by which a face image dataset suitable for AI model learning can be obtained.

The data creation device creates, by partially or wholly changing a creation parameter which is obtained by conversion of a source image of a freely-selected face to a numerical value, a larger number of input creation parameters than a predetermined number from the predetermined number of the creation parameters of the source images, and creates, by creating a face image data item on the basis of a plurality of the input creation parameters, a face image dataset including a plurality of the face image data items. The present technology is applicable to a data creation device.

### TECHNICAL FIELD

The present technology relates to a data creation device, a data creation method, and a programs, and more particularly, to a data creation device, a data creation method, and a program by which face image datasets that are suitable for AI model learning can be obtained.

### BACKGROUND ART

Famous face image datasets for use in learning AI (Artificial Intelligence) models of face recognizers and the like have conventionally been constructed from image data items regarding real faces collected from web sites or collected by actual measurement.

In addition, as a technology related to construction of face image datasets, there has been proposed a technology of preparing a plurality of images of real faces (real face images) and constructing a face image dataset by combining the plurality of real face images (see PTL 1, for example).

### CITATION LIST

### Patent Literature

### [PTL 1]

PCT Patent Publication No. WO2015/033431

### SUMMARY

### Technical Problem

According to the above-mentioned technology, however, a face image dataset that is suitable for AI model learning, specifically, a face image dataset in which privacy is protected and fairness is ensured, is difficult to obtain.

A face image dataset including image data items regarding real faces collected from websites or collected by actual measurement, for example, is not considered to be suitable from the viewpoint of privacy, and thus, may incur high ethical risks.

Particularly in recent years, reinforcement of the privacy laws and regulations including the GDPR (General Data Protection Regulation) and the regulations for fairness in AI is in progress inside and outside Japan. There has been a trend to stop publication of datasets that are constructed from real face image data items, due to the regulations, and also has been a trend for commercial use of such datasets to become tougher.

In addition, in a case where a face image dataset including real faces collected from websites, for example, or a face image dataset according to the technology described in PTL 1 is constructed, only images of real faces are used. This requires high construction cost and further makes ensuring of fairness tough.

That is, a face image dataset in which statistics of attributes such as age and gender are less biased, which means a face image dataset in which fairness is ensured, is required for proper AI model learning, but collecting such less biased real face images are practically difficult to collect.

The present technology has been achieved in view of the above circumstances, and is provided to obtain a face image dataset that is suitable for AI model learning.

### Solution to Problem

A data creation method according to one aspect of the present technology is performed by a data creation device and includes a step of, by partially or wholly changing a creation parameter which is obtained by conversion of a source image of a freely-selected face to a numerical value, creating a larger number of input creation parameters than a predetermined number from the predetermined number of the creation parameters of the source images, and a step of, by creating a face image data item on the basis of a plurality of the input creation parameters, creating a face image dataset including a plurality of the face image data items.

A program according to the one aspect of the present technology is a program that corresponds to the data creation method according to the one aspect of the present technology.

A data creation device according to the one aspect of the present technology includes a parameter creation section that, by partially or wholly changing a creation parameter which is obtained by conversion of a source image of a freely-selected face to a numerical value, creates a larger number of input creation parameters than a predetermined number from the predetermined number of the creation parameters of the source images, and a dataset creation section that, by creating a face image data item on the basis of a plurality of the input creation parameters, creates a face image dataset including a plurality of the face image data items.

According to the one aspect of the present technology, a creation parameter which is obtained by conversion of a source image of a freely-selected face to a numerical value is partially or wholly changed, and a larger number of input creation parameters than a predetermined number is thereby created from the predetermined number of the creation parameters of the source images. A face image data item is created on the basis of a plurality of the input creation parameters, and a face image dataset including a plurality of the face image data items is thereby created.

### BRIEF DESCRIPTION OF DRAWINGS

FIG. 1 is a diagram depicting a configuration example of a data creation device.

FIG. 2 is a diagram for explaining an approach to create a face image dataset.

FIG. 3 is a diagram for explaining a process flow to create a face image dataset.

FIG. 4 is a diagram for explaining scrambling on creation parameters.

FIG. 5 is a diagram for explaining face ID labeling.

FIG. 6 is a diagram for explaining face ID cleansing.

FIG. 7 is a diagram for explaining attribute labeling and cleansing.

FIG. 8 is a flowchart of a dataset creation process.

FIG. 9 is a diagram depicting a configuration example of a computer.

### DESCRIPTION OF EMBODIMENT

Hereinafter, an embodiment to which the present technology is applied will be explained with reference to the drawings.

### First Embodiment

### Present Technology

The present technology constructs a face image dataset including face image data items regarding only imaginary faces created by a face creator without using any real face image, that is, without including face image data items regarding real face images. Accordingly, a face image dataset in which privacy is protected, or a face image dataset which is free of personal information, can be obtained.

In addition, in the present technology, a creation parameter obtained from a prepared source image (inputted image) is partially or wholly changed to increase the volume of the source image for creating a face image dataset, and also to increase face variations.

The creation parameter includes a plurality of parameters that potentially contain face features of faces such as eyes and colors of human faces and hair styles, specifically, facial appearance features of faces. In response to input of the creation parameter into a face creator, a face image (face image data item) can be obtained as output from the face creator. Such a creation parameter is also called a latent variable.

Further, according to the present technology, the creation parameter of a source image the volume of which has been greatly increased is inputted to a face creator to obtain a face image data item, and labeling and cleansing are performed on a plurality of the obtained face image data items, whereby a face image dataset is obtained.

In labeling, an attribute value of an attribute that a face image based on a face image data item has and a face ID are imparted to the face image data item. In labeling, particularly, imparting an attribute value and a face ID, that is, annotating, is automatically performed without manpower.

An attribute herein refers to a feature of a face indicated by a face image (a feature for describing how the face looks), such as age, gender, expression, eye shape, or the color of hair, for example, and a face ID herein refers to an identification ID for identifying a face that is indicated by the face image. For example, faces imparted with the same face ID are similar to each other, that is, are faces of the same person.

In addition, in cleansing, statistics (distribution) of attribute values of attributes that face image data items constituting a face image dataset have, the number of face IDs, a resolution of the face image data items, and the number (data amount) of the face image data items constituting the face image dataset are determined such that desired statistics, resolution, and data amount are obtained. Specifically, for example, face image data thinning, which means deleting some of face image data items, and downsampling or upsampling of face image data items are performed.

As a result of the above-mentioned source image volume increase, labeling, and cleansing, the statistics of attributes and the like in a face image dataset can be made less biased. That is, fairness can be achieved, and a face image dataset that complies with a data amount, resolution, attributes, and statistics requested by a customer, such as an AI developer, can be constructed at low cost.

In particular, in volume increase of a source image, a face image is not directly edited but a creation parameter thereof is controlled. That is, the creation parameter is partially or wholly changed. Accordingly, a variety of faces having many different attributes (attribute values) and face IDs can be created.

Moreover, which face feature (attribute) of a face is changed depending on which part is determined as a target of creation parameter control is already known. Therefore, a creation parameter can be controlled to change (control) a face image in such a manner as to obtain a desired attribute value. Consequently, a face image having an attribute value that is likely to be insufficient when actual measurement is conducted and a face image complying with attributes and statistics requested by a customer, such as an AI developer, can easily be created, whereby the construction cost of face image datasets can be reduced.

For example, in an example of one actual embodiment, imaginary face images, real face images provided from customers, and the like can be used as source images (inputted images) to be subjected to the volume increase.

In addition, the data amount, resolution, attributes, attribute statistics (distribution of the attribute values of respective attributes), and the like of a desired final face image dataset may be designated as a target value by a customer, and a face image dataset may be created with the target values as input (input parameter).

Face image data items, an index file in which the face image data items are associated with face IDs and attribute labels, sample thumbnail images of the face images, and an attribute statistics data file indicating attribute statistics of respective attributes may be included in the file of a final face image dataset.

In such a case, for example, in a face image dataset creating process, several thousand preset face images which are prepared in advance may be combined with each source image (inputted image), a face image of an intermediate face between a face based on the source image and a face of each of the preset face images may be created, and the created face images may be inputted to a face creator.

Here, combining a source image and a preset face image is not combining the images, and is conducted in the space of creation parameters. That is, a creation parameter of the source image and a creation parameter of the preset face image are combined, whereby a creation parameter of a face image of the intermediate face is created.

For example, if an average value of a creation parameter of a face image A having a predetermined appearance feature and a creation parameter of a face image B having an appearance feature different from that of the face image A is inputted to a face creator, a face image having an intermediate appearance feature between the face image A and the face image B can be obtained.

Moreover, in order to obtain faces of wider attribute variations, creation parameters of source images and preset face images may be edited (controlled) before being combined.

Creation parameters of a large number of the intermediate face images obtained as described above are inputted to a face creator, and then, face image data items according to the creation parameters of the intermediate face images are created.

Thereafter, labeling is performed by clustering on the face image data items by means of an attribute classifier or the like. Accordingly, a statistic amount of attribute values, that is, attribute statistics, are calculated. Then, cleansing is performed in such a manner as to make the calculated attribute statistics equal to the target value, that is, the attribute statistics designated by the customer. Accordingly, a final face image dataset is created.

### Configuration Example of Data Creation Device

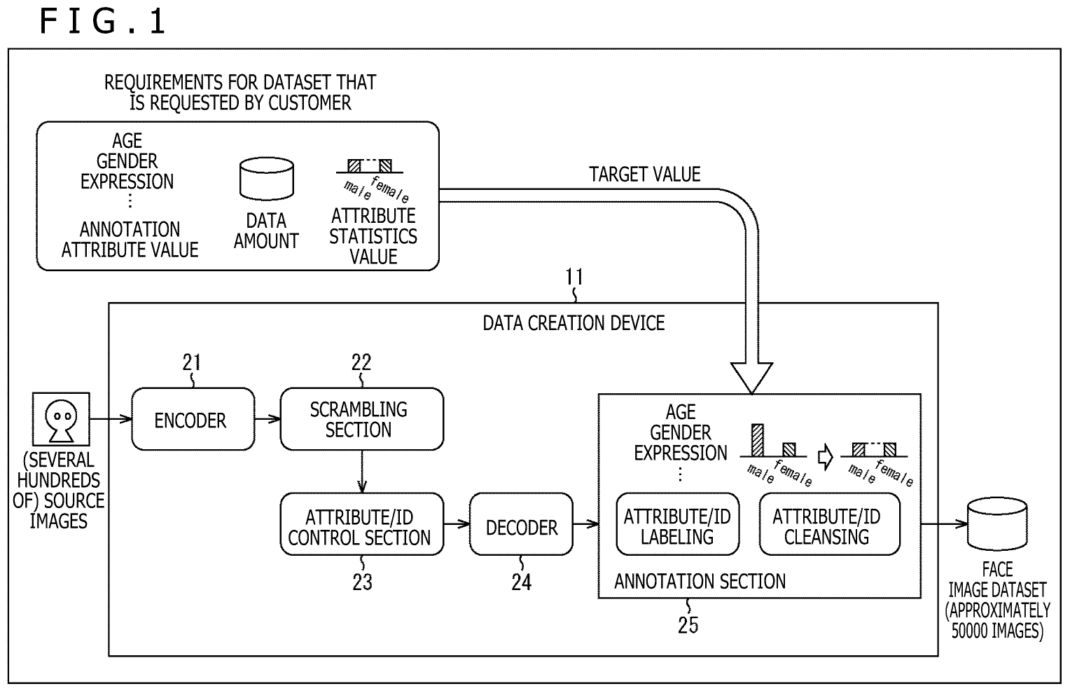

FIG. 1 is a diagram depicting a configuration example of a data creation device to which the present technology is applied.

A data creation device 11 depicted in FIG. 1 includes, for example, a personal computer, and creates a face image dataset on the basis of an inputted source image and a target value. In one example, the data creation device 11 can construct a face image dataset including approximately 50000 face images from only a few hundreds of source images.

The data creation device 11 includes an encoder 21, a scrambling section 22, an attribute/ID control section 23, a decoder 24, and an annotation section 25.

For example, image data items regarding a plurality of source images (inputted images) prepared in advance is supplied to the encoder 21. The source images are, for example, real face images provided by a customer, face images of imaginary faces created by a face creator, and the like, as previously explained.

For example, the encoder 21 includes a parameter estimator that, in response to input of an image data item regarding a face image, outputs a creation parameter (latent variable) corresponding to the face image, which means a creation parameter obtained by converting a face feature to numerical value data to conceal the face feature.

The encoder 21 converts an inputted source image to a numerical value by performing a computation process based on the supplied face image data item regarding the source image, and supplies creation parameters of respective source images obtained by the conversion, to the scrambling section 22.

For example, a creation parameter includes parameters of a plurality of layers. Specifically, the creation parameter includes a plurality of layers, and each of the layers includes a predetermined number of parameters. In which layer constituting a creation parameter parameters should be changed (controlled) to change what feature (attribute) of a face image (face) created according to the creation parameter is already known.

As a result of conversion, at the encoder 21, of a face image data item regarding a source image to a creation parameter expressed by a numerical value, personal information (features) regarding a face included in the source image is diluted to a certain extent. Thus, the privacy can be protected.

The scrambling section 22 scrambles the creation parameters of source images supplied form the encoder 21, and supplies the scrambled creation parameters to the attribute/ID control section 23. For example, in scrambling of a creation parameter, a freely-selected random noise is added to the creation parameter, and then, the resultant creation parameter is used as a scrambled creation parameter.

As a result of the above-described scrambling of creation parameters that are obtained by converting source images to numerical values, the source images are unreconstructable from the creation parameters. Accordingly, privacy protection can be further enhanced.

The attribute/ID control section 23 creates, on the basis of a creation parameter supplied from the scrambling section 22, a plurality of new creation parameters (hereinafter, also referred to as input creation parameters) that are obtained by partially or wholly controlling (changing) the creation parameter, and supplies the newly created creation parameters to the decoder 24.

In other words, the attribute/ID control section 23 functions as a parameter creation section that, by partially or wholly changing a creation parameter obtained by converting a source image of a freely-selected face to a numerical value, creates a larger number of input creation parameters than a predetermined number, from the predetermined number of creation parameters of source images.

For example, if only a specific parameter among the creation parameters is gradually changed to create a plurality of input creation parameters, a large number of input creation parameters of face images having different features (attributes) such as age can be obtained. That is, the variation of facial appearance features (attributes) can be increased.

It is to be noted that an input creation parameter obtained from a source image and a creation parameter of a freely-selected preset face image prepared in advance may be combined to create a final input creation parameter, which will be explained later.

The decoder 24 includes a face creator that receives input creation parameters as input and that outputs face image data items, for example. The decoder 24 functions as a dataset creation section that creates a face image dataset by creating face image data items on the basis of a plurality of input creation parameters.

At the face creator, input creation parameters are converted into face image data items by such a method as a GAN (Generative Adversarial Network) or a VAE (Variational AutoEncoder), for example. Consequently, face image data items regarding faces having different appearance features are obtained according to the different input creation parameters.

With use of the face creator, photo-realistic artificial face images can be obtained, and further, a large number of face images having different features can be created by controlling (changing) creation parameters. In addition, the face creator is also capable of creating a face image data item at a designated resolution.

The decoder 24 creates a face image data item according to the input creation parameters by performing computation based on the input creation parameters supplied from the attribute/ID control section 23, and supplies the face image data item to the annotation section 25.

A target value that indicates a requirement (hereinafter, also referred to as a customer requirement) for a face image dataset requested by a customer is supplied to the annotation section 25.

As previously explained, a target value is a data amount (number) of face image data items constituting a face image dataset, the resolution of the face image data items, an attribute to be subjected to labeling, such as age, attribute statistics indicating a distribution of attribute values of each attribute, etc., designated by a customer, for example. That is, a target value represents at least any one of a data amount, a resolution, an attribute to be subjected to labeling (labeling attribute), and attribute statistics.

The annotation section 25 creates (constructs) a face image dataset satisfying a customer requirement, on the basis of the supplied target value and face image data items supplied from the decoder 24, and outputs the face image dataset to the next stage such as an undepicted recording section.

That is, the annotation section 25 creates a final face image dataset satisfying the customer requirement, by performing attribute labeling and cleansing (cleaning) and face ID labeling and cleansing on the face image dataset (face image data items).

At the annotation section 25, particularly, labeling and cleansing can be performed, for example, by an any existing clustering technique or similarity calculation technique, or by using an attribute estimator that is obtained as a result of pre-learning, without requiring a manager's designation operation or the like, that is, without manpower.

Cleansing is a bias removing process of removing a bias in statistical data regarding attributes of a plurality of face image data items. Specifically, in cleansing, attribute statistics control is performed by deleting (removing) some of face image data items constituting a face image dataset, in such a way that attribute statistics indicated by the target value are obtained, for example.

It is to be noted that, more specifically, the annotation section 25 creates a file (face image dataset file) of a face image dataset including face image data items, an index file in which the face image data items are associated with face IDs and attribute labels, sample thumbnail images of the face images, and an attribute statistics data file indicating attribute statistics of respective attributes.

### <Creation of Face Image Dataset>

Next, a process that is performed by the sections in the data creation device 11, which means creation of a face image dataset, will be explained in more detail.

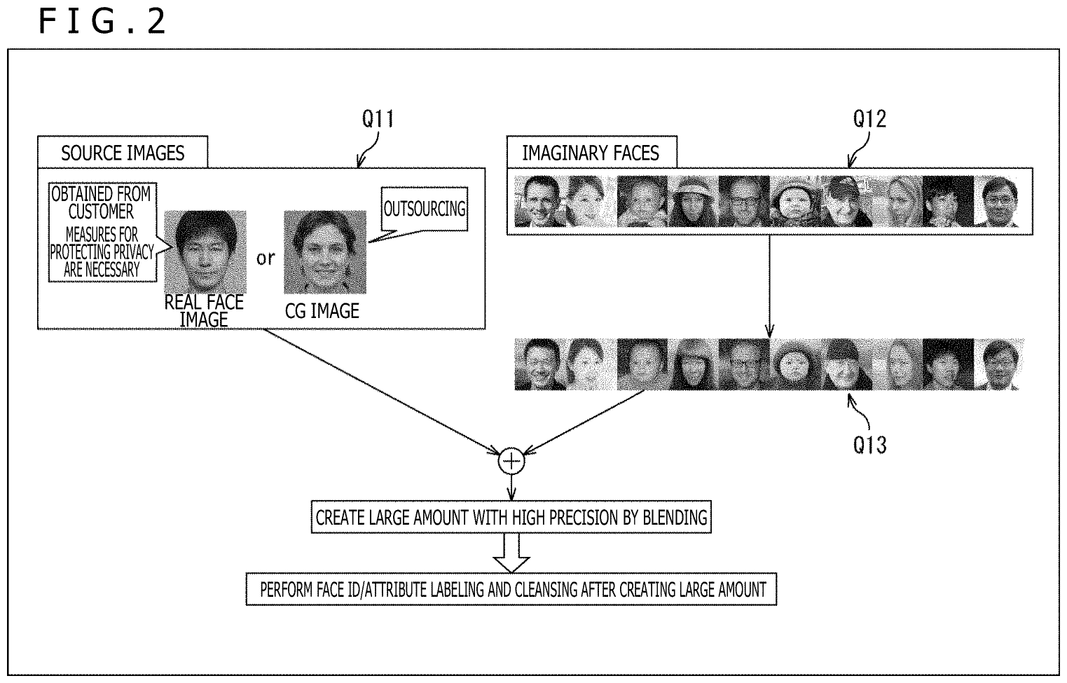

In the data creation device 11, a face image dataset is created according to an approach roughly depicted in FIG. 2.

That is, a plurality of source images are first prepared, as pointed by arrow Q11. For example, real face images provided by a customer, face images of imaginary faces, that is, CG (Computer Graphics) images created by outsourcing or the like, or the like are used as the source images.

For example, in a case where real face images are used as the source images, the number of real face images that can be prepared as the source images is small, but high-precision face images, that is, images of faces which are normal as faces, can be used. In a case where real face images are used as the source images, however, measures to protect the privacy have to be taken. Therefore, conversion to numerical values at the encoder 21 and scrambling at the scrambling section 22 are performed in the data creation device 11 as the measures.

In addition, in a case where preset face images are used to create final input creation parameters, a large number of imaginary face images are prepared, as pointed by arrow Q12, for example. These imaginary face images are, for example, face images randomly created by a freely-selected face creator, for example.

When imaginary face images are created by the face creator, a large number of face images can easily be prepared. However, imaginary face images randomly created by the face creator include a low precision face image, that is, an abnormal face image that has a low face-likeness. Moreover, there is a possibility that, in the plurality of imaginary face images randomly created, the number of face images that have a desired feature (attribute) such as a Japanese face, for example, may be insufficient.

In view of this, low-precision imaginary face images (unsuitable imaginary face images) are removed from a group of the imaginary face images pointed by arrow Q12, that is, imaginary face image screening is performed, or the imaginary face images are edited to obtain imaginary face images having a desired feature, for example, so that a set of a plurality of preset face images pointed by arrow Q13 is created.

For example, editing an imaginary face image in order to obtain a preset face image is implemented by, for example, changing a predetermined parameter constituting the creation parameter of the imaginary face image.

At the attribute/ID control section 23, a creation parameter of a preset face image which is an imaginary face image prepared in advance in the above-mentioned manner and an input creation parameter obtained from a source image are blended to create a final input creation parameter.

In blending, weighted addition of a creation parameter of a preset face image and an input creation parameter is performed according to a predetermined weight, for example. In this case, when ½ is set as the weight, the average value of the creation parameter of the preset face image and the input creation parameter is obtained as a final input creation parameter.

As a result of the above-mentioned blending, a large number of parameters that are suitable for input to the decoder 24 can be created with high precision as final input creation parameters.

In particular, final input creation parameters at least as many as combinations of a plurality of input creation parameters created from source images and creation parameters of a plurality of preset face images can be created here. Further, more input creation parameters can be created by changing the blend ratio (weight) of the blending.

It is to be noted that, on the basis of a data amount that is a target value, the attribute/ID control section 23 may create final input creation parameters in such a way that the number of the final input creation parameters corresponds to the data amount. In such a case, it is sufficient if input creation parameters more than the number indicated by the data amount are created while the cleansing at the annotation section 25 is taken into consideration.

In addition, when input creation parameters are obtained, the decoder 24 creates a large number of face image data items on the basis of the input creation parameters. Face ID labeling and cleansing and attribute labeling and cleansing are performed on the obtained face image data items, whereby a face image dataset is created. As a result of this cleansing, a customer requirement is satisfied, and fairness is achieved.

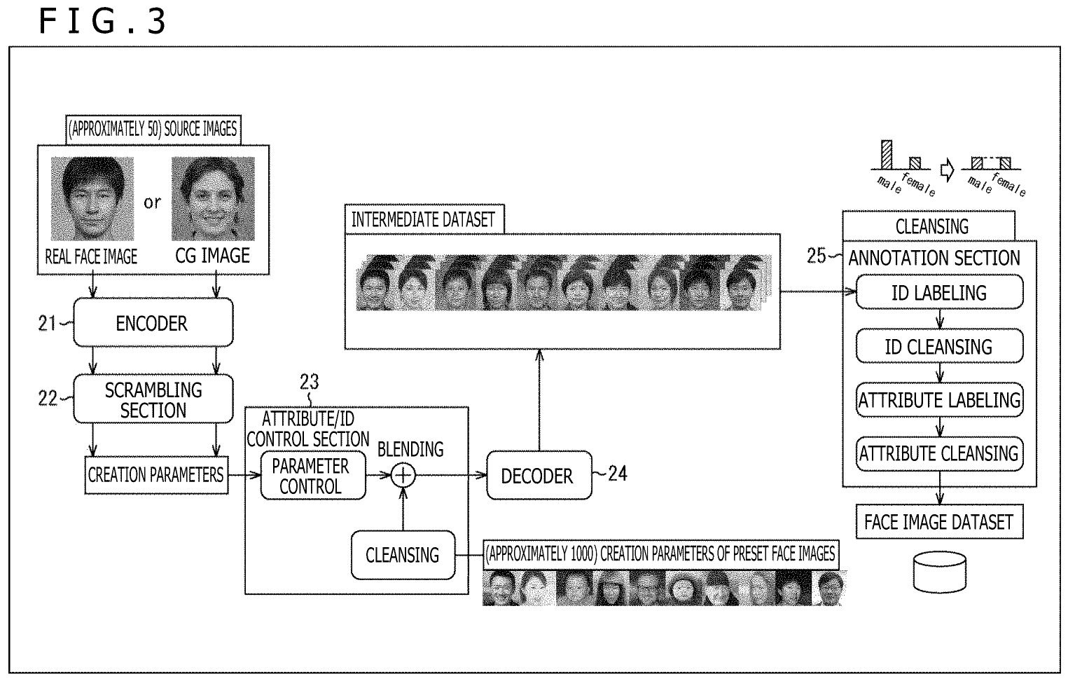

FIG. 3 depicts a detailed process flow to create a face image dataset in the data creation device 11. It is to be noted that, in FIG. 3, a section corresponding to that in FIG. 1 is denoted by the same reference sign, and an explanation thereof will be omitted as appropriate.

In the example in FIG. 3, real face images and CG images are used as source images, as depicted in the upper left part of FIG. 3, and the source images are converted to creation parameters by the encoder 21 (parameter estimator). Then, scrambling, that is, privacy filtering, is performed on these creation parameters at the scrambling section 22, and the resultant creation parameters are inputted to the attribute/ID control section 23.

Here, from the viewpoint of privacy protection, scrambling should be performed on real face images that are source images, but it is not necessarily required to perform scrambling on CG images that are source images.

As a result of the process up to the scrambling described above, creation parameters of precise (human face-like) imaginary face images can be obtained although the number of the obtained creation parameters is small.

The attribute/ID control section 23 creates a plurality of input creation parameters from one creation parameter by, for example, stepwisely changing (increasing or reducing), in increments/decrements of a predetermined value, a predetermined one of a plurality of parameters constituting a creation parameter supplied from the scrambling section 22. Here, if a parameter to be controlled (changed) in the creation parameters is sequentially changed, more input creation parameters can be created.

Accordingly, the volume of the original source image is significantly increased, so that more input creation parameters having a wider variety of attribute values and face IDs are obtained.

It is to be noted that an attribute, a data amount, attribute statistics, and the like designated as a target value by a customer may be used to control a creation parameter, if needed. When the creation parameter is controlled on the basis of such a target value, a required number of face image data items of required attributes are surely obtained. Accordingly, customer requirements are surely satisfied at low cost.

In addition, cleansing is performed as appropriate on creation parameters of a plurality of preset face images, which have been explained with reference to FIG. 2, at the attribute/ID control section 23.

For example, in the cleansing, low-precision preset images that do not look like human faces are removed from a group of the preset face images, and preset face images having a predetermined attribute value are removed in order to prevent creation of a biased distribution of the attribute values, if the number of the preset face images is excessively large.

At the attribute/ID control section 23, cleansing may be performed according to a designation operation or the like performed by a manager, or cleansing may be performed on the basis of a model of an attribute estimator or the like and a target value representing a customer requirement, without requiring any designation operation or the like performed by a manager.

With use of a target value, a customer requirement can be surely satisfied at low cost even in cleansing of preset face images, for example, in the same manner as that in the input creation parameter creation time.

Further, at the attribute/ID control section 23, the created input creation parameters and the creation parameters of the preset face images having undergone the cleansing are blended to create a large number of final input creation parameters, and the final input creation parameters are inputted to the decoder 24.

Here, while the blend ratio of the blending and combinations of input creation parameters and creation parameters of preset face images to be combined are changed, a large number of input creation parameters are created. Accordingly, more input creation parameters having a wider variety of attribute values and face IDs with less biased attribute values and the like can be obtained at low cost.

At the decoder 24, face image data items are created on the basis of input creation parameters supplied from the attribute/ID control section 23, and an intermediate dataset including the plurality of created face image data items is supplied to the annotation section 25.

At the annotation section 25, labeling (annotating) and cleansing are performed on the face image data items constituting the supplied intermediate dataset.

Specifically, face ID labeling of imparting respective face IDs to the face image data items, for example, is followed by cleansing on the face image data items imparted with the face IDs.

In addition, attribute labeling, that is, attribute value imparting, is performed on the face image data items remaining after the face ID cleansing, and cleansing is performed on the face image data items imparted with attribute values, whereby a face image dataset including the finally remaining face image data items is obtained. Accordingly, a face image dataset in which privacy is protected and the precision (human likeness) of face images and fairness are assured to satisfy a customer requirement can be obtained. In other words, a face image dataset suitable for AI model learning suitable for AI model learning can be obtained.

Meanwhile, in scrambling of a creation parameter of a source image, a random noise, which means a numerical value (random number) that is randomly created, is added to a parameter in a particular layer of a plurality of layers constituting the creation parameter, whereby a scrambled creation parameter is obtained.

Here, a plurality of random noises to be added to a creation parameter can be generated, and a process of adding each of the random noises to the creation parameter can be performed, thereby making it possible to obtain, from one creation parameter, a plurality of new creation parameters between which the similarity is low, that is, the unlikeness is high. In other words, a plurality of scrambled creation parameters having different face IDs (the distance between the face IDs is long) can be obtained from one creation parameter and a plurality of random noises.

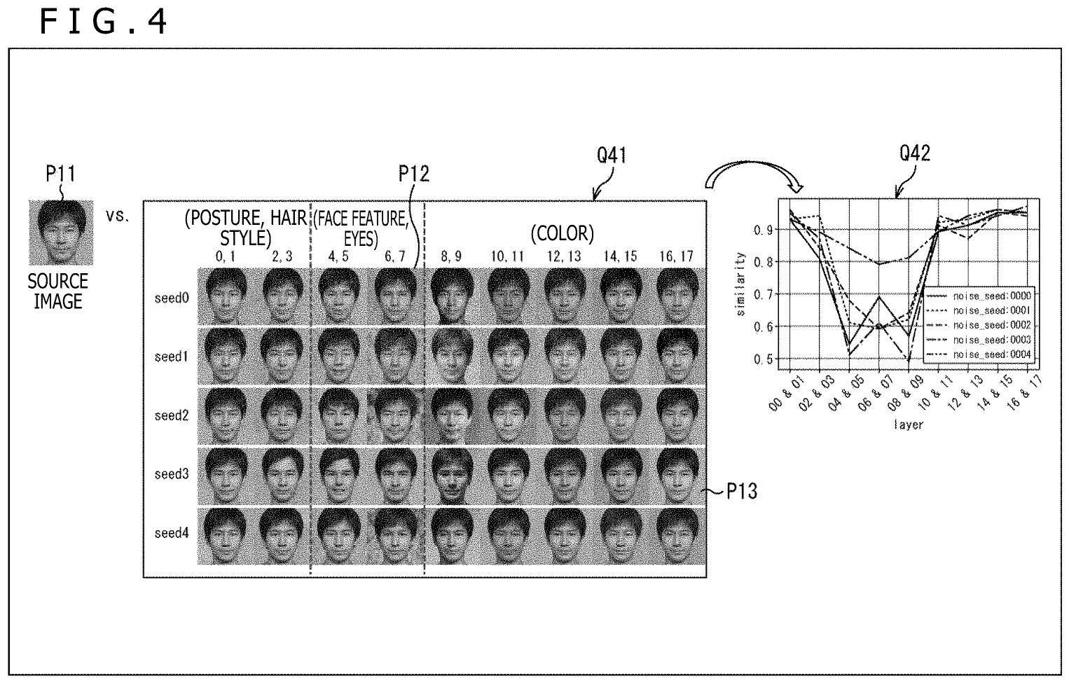

Here, an example of a similarity to a face of an original source image when a random noise is added to a particular layer in scrambling will be explained with reference to FIG. 4.

In this example, it is assumed that a predetermined source image P11 is used to obtain a creation parameter and the creation parameter is scrambled.

A part pointed by arrow Q41 presents face images based on a scrambled creation parameter which is obtained by scrambling a creation parameter obtained from the source image P11.

In the part pointed by arrow Q41, numerical values indicated in the horizontal direction each represent a layer, of the layers constituting the creation parameter, to which a random noise has been added. Here, the creation parameter includes 18 layers which are a zero-th to seventeenth layers.

In addition, in the part pointed by arrow Q41, the terms “seed0” to “seed4” indicated in the vertical direction each represent a seed (numerical value) having been used to create a random noise. Hereinafter, a random noise generated by a seed “seed0” is also referred to as a random noise “seed0,” for example.

For example, a face image P12 is a face image obtained by adding a random noise “seed0” to the sixth and seventh layers of the creation parameter of the source image P11. Likewise, for example, a face image P13 is a face image obtained by adding a random noise “seed3” to the sixteenth and seventeenth layers of the creation parameter of the source image P11.

From face images in the part pointed by arrow Q41, it can be seen that a posture and a hair style change when a random noise is added to the zero-th to third layers, and that a face feature such as eyes changes when a random noise is added to the fourth to seventh layers. It can also be seen that a face color changes when a random noise is added to the eighth to seventeenth layers.

The similarities of face images obtained by the above-described scrambling to the original source image P11 were calculated by means of a face authenticator. The results are presented in a part pointed by arrow Q42.

In the part pointed by arrow Q42, the horizontal axis indicates a layer to which a random noise was added while the vertical axis indicates a similarity.

It can be seen that, in this example, the similarity was significantly reduced when the random noise was added to any one of the fourth to ninth layers, irrespective of which kind of seeds the random noise was, whereby a face having appearance features different from those of the original source image P11 was obtained. Therefore, it can be understood that, if a random noise is added to any one or more of the fourth to ninth layers, scrambling can be performed more effectively.

Next, an explanation will be given of face ID labeling and cleansing and attribute labeling and cleansing which have been explained with reference to FIG. 3.

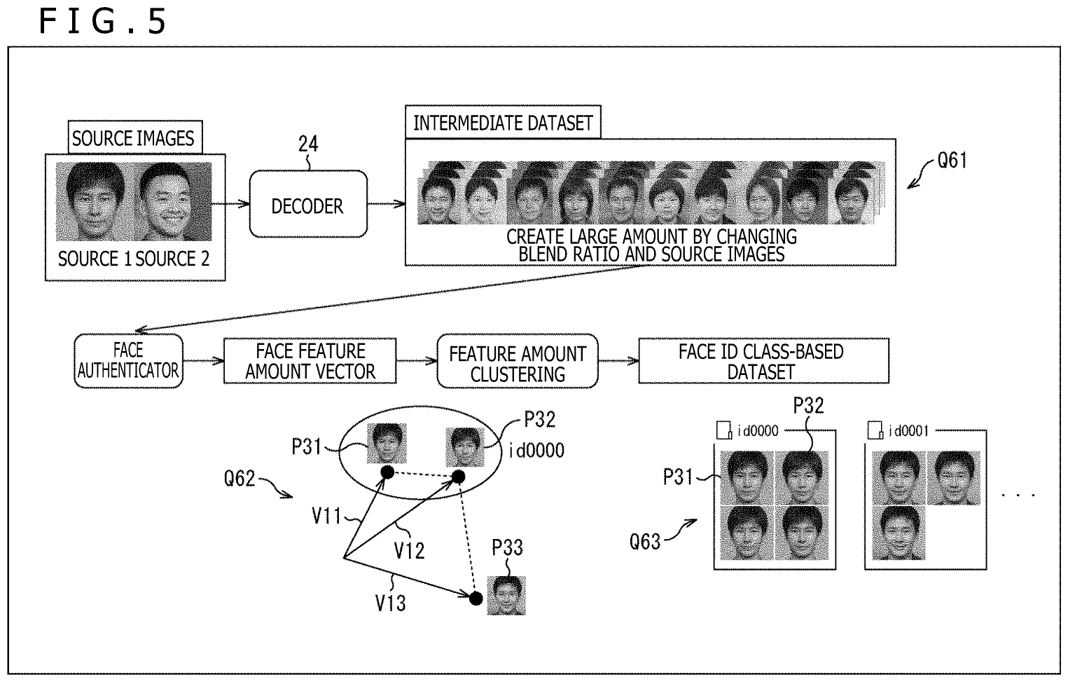

For example, input creation parameters obtained from source images are inputted to the decoder 24 to create an intermediate dataset including a plurality of face image data items, as pointed by arrow Q61 in FIG. 5.

Then, at the annotation section 25, the face image data items constituting the intermediate dataset are inputted to a face authenticator, and face feature amount vectors of the respective face image data items are outputted as a computation result at the face authenticator. The face feature amount vectors are each a vector representing a facial appearance feature that the face image data item has.

The annotation section 25 performs feature amount clustering such as DBSCAN (Density-Based Spatial Clustering of Applications with Noise), for example, on all the face feature amount vectors outputted from the face authenticator. As a result, respective face IDs are imparted to the face image data items constituting the intermediate dataset. That is, face ID labeling is performed.

Specifically, it is assumed that a face feature amount vector V11 to a face feature amount vector V13 are obtained for respective face image data items which are face images P31 to P33, as pointed by arrow Q62, for example.

Here, among the face images P31 to P33, face images having face feature amount vectors between which the cosine distance is short are classified into the same face ID class. Then, the same face ID is imparted to face images (face image data items) belonging to the same face ID class, as pointed by arrow Q63.

In this example, a face ID “id0000” is imparted to all the face images belonging to a face ID class including the face image P31 and the face image P32.

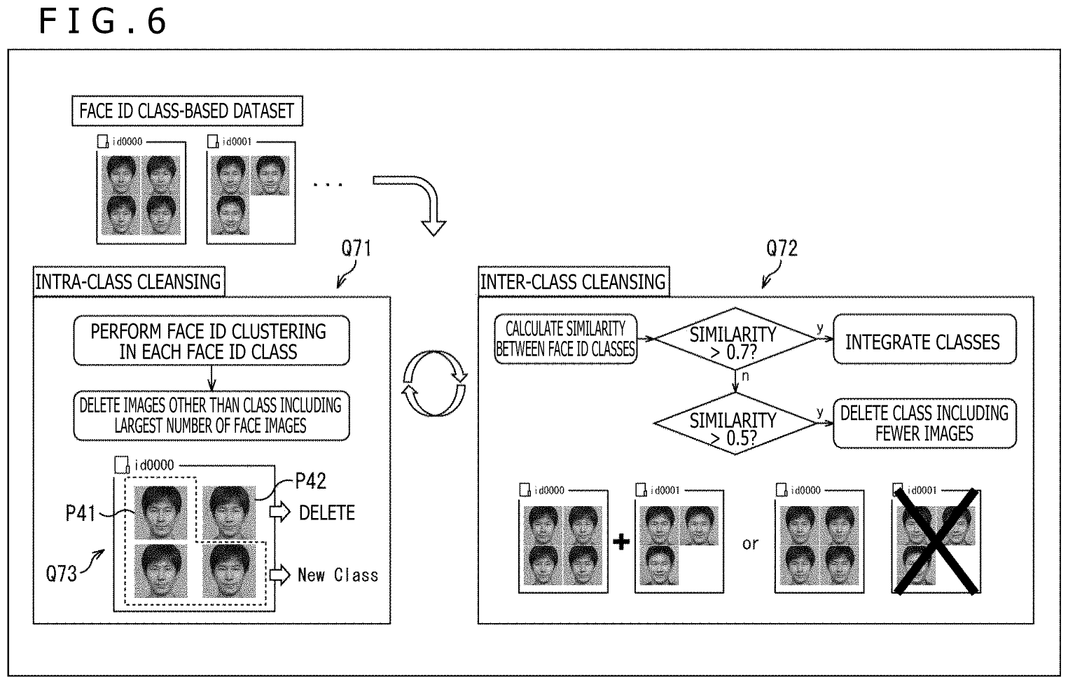

After the face image data items constituting an intermediate dataset are classified into any one of the face ID classes in the above-mentioned manner, face ID cleansing is performed on the face IDs, as depicted in FIG. 6, for example.

Specifically, in the face ID cleansing, intra-class cleansing which is pointed by arrow Q71 and inter-class cleansing which is pointed by arrow Q72 are alternately performed.

That is, in the intra-class cleansing, feature amount clustering such as DBSCAN, which is similar to that in the labeling, is performed on the face image data items belonging to a face ID class to be processed. Then, when a plurality of classes are obtained as a result of the feature amount clustering, face image data items excluding face image data items belonging to a class including the largest number of face image data items are deleted.

Specifically, it is assumed that, for example, intra-class cleansing is performed on a face ID class having a face ID “id0000,” which includes four face images including a face image P41 and a face image P42, as pointed by arrow Q73.

In this case, feature amount clustering is performed on the four face images as targets. Further, it is assumed that three face images including the face image P41 are classified into one class while the remaining one face image P42 is classified into the other class as a result of the feature amount clustering. In this case, the face image P42 is deleted, and the class including face image data items regarding the three face images including the face image P41, to which the largest number of face images belong, is defined as a post-intra-class cleansing face ID class of the face ID “id0000.”

Further, in the inter-class cleansing pointed by arrow Q72, the similarity between freely-selected two face ID classes is calculated. Then, if the similarity between the face ID classes is greater than 0.7, the two face ID classes are integrated into one new face ID class.

Here, the face ID of a face ID class to which the larger number of face image data items belong is adopted as a face ID of the integrated face ID class.

In addition, for example, in a case where the similarity between two face ID classes is greater than 0.5 but is equal to or less than 0.7, among these two face ID classes, the face ID class to which a smaller number of face image data items belong is deleted, or more specifically, the face image data items belonging to the face ID class are deleted.

On the other hand, for example, when the similarity between two face ID classes is equal to or less than 0.5, these two face ID classes are left as they are.

The annotation section 25 alternately repeats the above-mentioned intra-class cleansing and inter-class cleansing a predetermined number of times or until convergence, and then, performs attribute labeling and cleansing on the face image data items of a plurality of the finally remaining face ID classes.

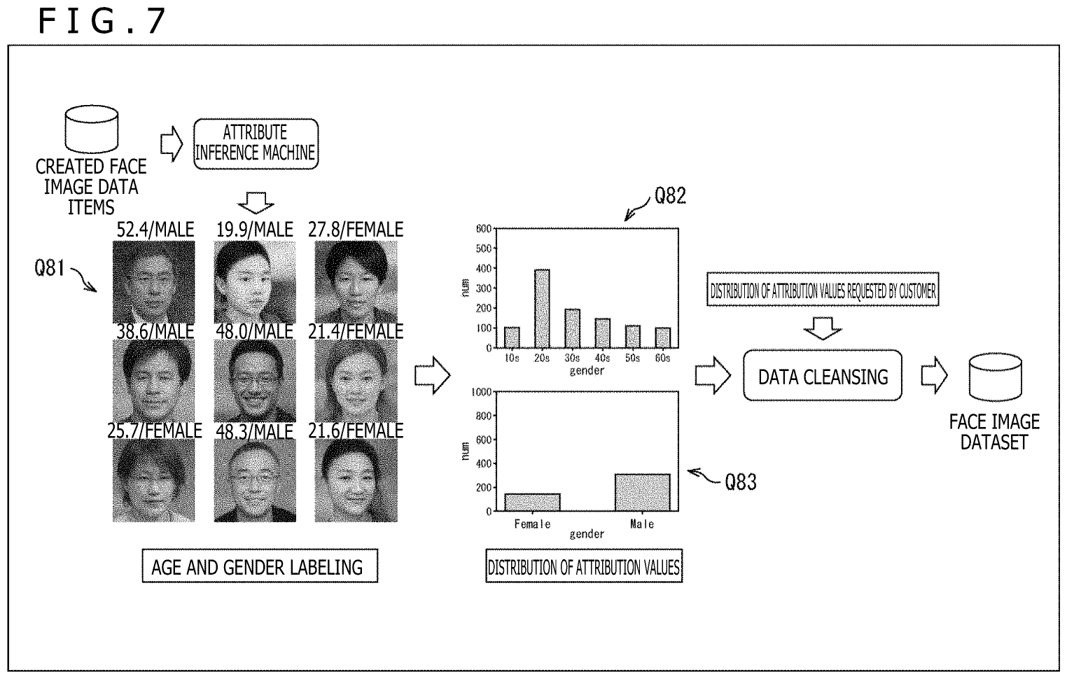

Specifically, as depicted in FIG. 7, for example, the annotation section 25 inputs face image data items to be subjected to attribute labeling, that is, face image data items belonging to a face ID class, to an attribute estimator, performs computation, and obtains, as output, attribute values of the face image data items in regards to a desired attribute. Accordingly, it is considered that labeling for the face image data items has been performed in regards to an attribute indicated by a customer requirement, that is, a target value.

In this example, labeling for age and gender which are attributes is performed on face image data items, as pointed by arrow Q81. In particular, numerical values above face images pointed by arrow Q81 each represent an attribute value of an attribute “age” imparted to the corresponding face image (face image data item), and the word “male” or “female” next to the numerical values represents an attribute value of an attribute “gender” imparted to the corresponding face image.

In addition, after the attribute labeling is performed, attribute statistics indicating a distribution of the attribute values of the respective face image data items are obtained on the basis of the attribute values. In this example, the attribute statistics regarding the attribute “age” pointed by arrow Q82 and the attribute statistics regarding the attribute “gender” pointed by arrow Q83 are obtained.

Further, face image data cleansing is performed on the basis of the attribute statistics of each of the attributes and the target value which are obtained as described above.

That is, some of the face image data items are deleted as appropriate, in such a way that final attribute statistics of the face image dataset are compliant with the attribute statistics indicated by the target value and that the number of face image data items (data amount) constituting the face image dataset is equal to a data amount indicated by the target value, for example. Further, a dataset including the remaining face image data items is adopted as a final face image dataset. It is to be noted that, here, a resolution conversion process such as downsampling or upsampling may be performed on the face image data items if needed, in such a way that the resolution of each face image data item becomes equal to the resolution indicated by the target value.

As a result of the above-mentioned process, a face image dataset satisfying the customer requirement is finally obtained.

### <Explanation of Dataset Creation Process>

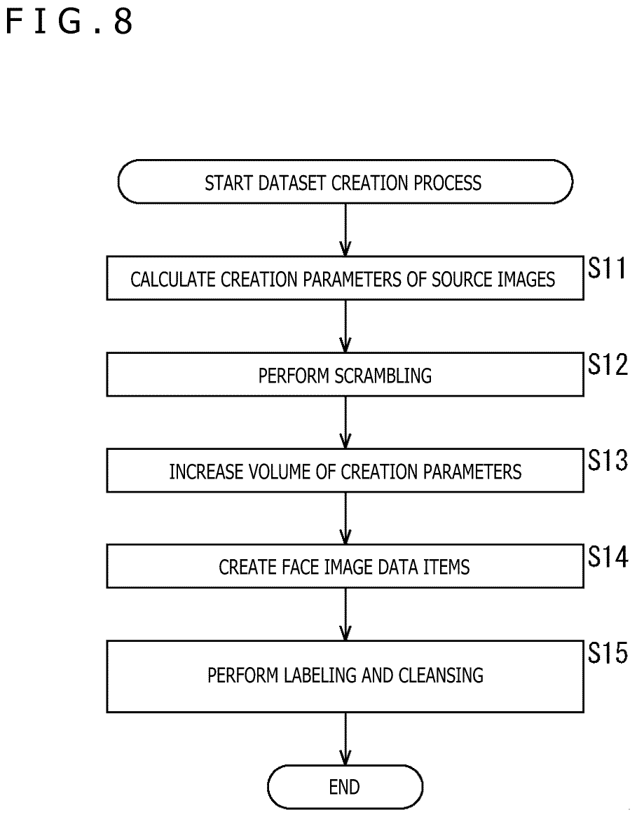

Finally, a dataset creation process that is performed by the data creation device 11 will be explained. Specifically, an explanation of the dataset creation process that is performed by the data creation device 11 will be given below with reference to a flowchart in FIG. 8.

In step S11, the encoder 21 calculates estimated creation parameters of respective supplied source images by inputting face image data items regarding the source images to a parameter estimator and performing computation, and supplies the obtained creation parameters to the scrambling section 22.

In step S12, the scrambling section 22 scrambles the creation parameters of the source images supplied from the encoder 21, and supplies the scrambled creation parameters to the attribute/ID control section 23.

For example, the scrambling section 22 creates a scrambled creation parameter by adding a random noise created on the basis of a freely-selected seed, to a parameter in a particular layer in the creation parameter.

Here, for example, scrambling by each of a plurality of random noises may be performed, or a layer to which a random noise is added may be changed, to create a plurality of scrambled creation parameters from one creation parameter. In addition, in a case where the source images are imaginary face images, scrambling is not necessarily required to be performed.

In step S13, the attribute/ID control section 23 increases the volume of the creation parameters supplied from the scrambling section 22, on the basis of the creation parameters, and supplies, as input creation parameters, the new creation parameters obtained as a result of the volume increase, to the decoder 24.

For example, the attribute/ID control section 23 creates, from each of the creation parameters supplied from the scrambling section 22, a plurality of new input creation parameters, as previously explained with reference to FIG. 3. Here, the attribute/ID control section 23 creates the input creation parameters by, for example, changing a particular parameter constituting each creation parameter by a predetermined value, or changing a parameter part to be controlled (changed).

Moreover, the attribute/ID control section 23 performs cleansing on creation parameters of a plurality of preset face images prepared in advance, on the basis of a target value or the like, as appropriate, and blends the creation parameters of the preset face images and the input creation parameters, thereby final input creation parameters are obtained.

Here, the attribute/ID control section 23 creates a large number of final input creation parameters while changing the blend ratio of the blending by a predetermined value for each of combinations of the creation parameters of the preset face images and the input creation parameters to be blended, for example.

In step S14, the decoder 24 inputs the input creation parameters supplied from the attribute/ID control section 23 to a face creator, performs computation to create face image data items according to the input creation parameters, and supplies the face image data items to the annotation section 25.

In this case, the decoder 24 may input a resolution indicated by a target value and the input creation parameters to the face creator, to create face image data items at the resolution indicated by the target value, for example.

A dataset including a large number of the face image data items created by the decoder 24 is supplied as a non-final intermediate face image dataset, that is, as an intermediate dataset, to the annotation section 25.

In step S15, the annotation section 25 performs face ID labeling and cleansing and attribute labeling and cleansing on the basis of a target value indicating a customer requirement supplied from the outside and the intermediate dataset supplied from the decoder 24.

For example, the annotation section 25 imparts face IDs to face image data items by calculating respective face feature amount vectors of the face image data items by means of a face authenticator and performing feature amount clustering thereon, as previously explained with reference to FIG. 5. In addition, for example, the annotation section 25 performs face ID cleansing by performing intra-class cleansing and inter-class cleansing on the face image data items imparted with the face IDs, as previously explained with reference to FIG. 6. It is to be noted that, in a case where the number of face IDs is designated as the target value, for example, the annotation section 25 performs the cleansing in such a way that the number of face IDs in the cleansed face image dataset becomes equal to the number indicated by the target value.

Moreover, for example, the annotation section 25 creates a final face image dataset by performing, on the face image data items having undergone the face ID cleansing, attribute imparting (labeling) using an attribute estimator and cleansing based on the target value, as previously explained with reference to FIG. 7. Here, the annotation section 25 further performs a resolution conversion process on the face image data items, if needed.

More specifically, on the basis of the result of the labeling on the face image data items, the annotation section 25 creates an index file in which face IDs and attribute labels are associated with respective face image data items, sample thumbnail images of face images, and an attribute statistics data file of each attribute.

Then, the annotation section 25 creates a face image dataset file including the face image data items, the index file, the sample thumbnail images, and the attribute statistics data files, and outputs the face image dataset file to the next stage such as the recording section.

Accordingly, it is considered that the face image dataset in which the privacy is protected and the customer requirement is satisfied is obtained. Since attribute statistics indicating a non-biased distribution of attribute values are usually designated as a customer requirement (target value), the obtained face image dataset is a dataset in which fairness is assured is obtained.

It is to be noted that a customer requirement is not necessarily required to be designated. In a case where no customer requirement is designated, labeling and cleansing at the annotation section 25 are performed in such a way that a distribution of attribute values of each attribute is uniformized and that a predetermined number of face image data items is obtained, for example. Accordingly, a face image dataset in which privacy is protected and fairness is assured with a non-biased distribution of attribute values can be obtained.

After the final face image dataset is obtained in the above-mentioned manner, the dataset creation process ends.

As explained so far, the data creation device 11 converts source images into numerical values, increases the volume of creation parameters resulting from the conversion, and creates face image data items on the basis of input creation parameters obtained by the volume increase, and further, performs labeling and cleansing on the obtained face image data items.

Accordingly, a face image dataset suitable for AI model learning, that is, a face image dataset in which privacy is protected and fairness is assured, can be obtained at low cost.

### Configuration Example of Computer

The above-mentioned series of processes can be executed by hardware, or can be executed by software. In the case where the series of processes is executed by software, a program forming the software is installed into a computer. Here, examples of the computer include a computer incorporated in dedicated-hardware, a general-purpose personal computer capable of executing various functions by installing various programs thereinto, and the like, for example.

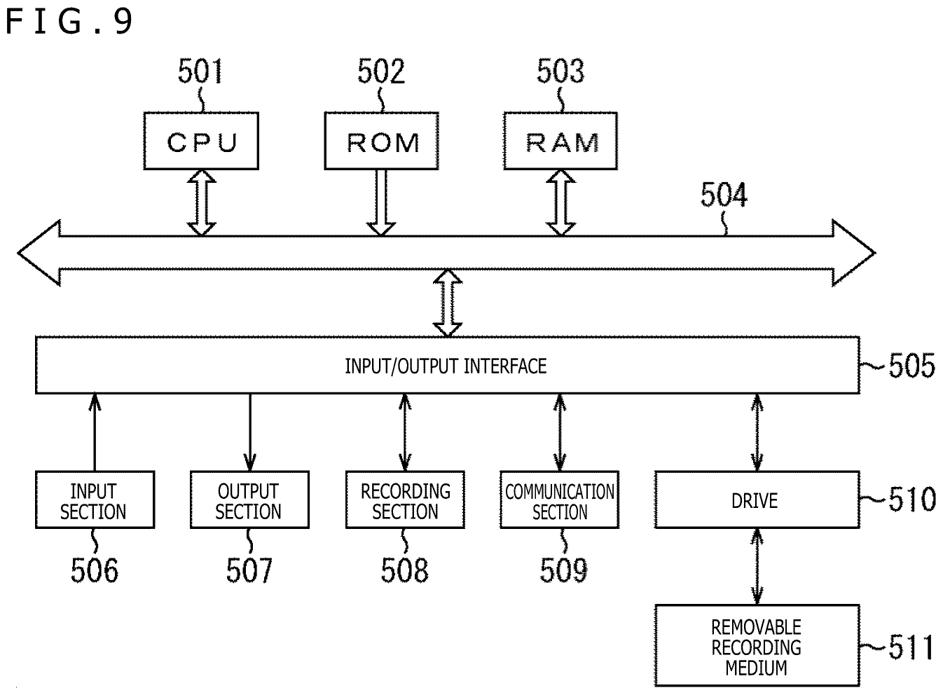

FIG. 9 is a block diagram illustrating a hardware configuration example of a computer that executes the above-mentioned series of processes according to a program.

In the computer, a CPU (Central Processing Unit) 501, a ROM (Read Only Memory) 502, and a RAM (Random Access Memory) 503 are mutually connected via a bus 504.

Further, an input/output interface 505 is connected to the bus 504. An input section 506, an output section 507, a recording section 508, a communication section 509, and a drive 510 are connected to the input/output interface 505.

The input section 506 includes a keyboard, a mouse, a microphone, an imaging element, or the like. The output section 507 includes a display, a loudspeaker, or the like. The recording section 508 includes a hard disk, a nonvolatile memory, or the like. The communication section 509 includes a network interface or the like. The drive 510 drives a removable recording medium 511 which is a magnetic disk, an optical disk, a magneto-optical disk, a semiconductor memory, or the like.

In the computer having the above-mentioned configuration, the CPU 501 loads a program recorded in the recording section 508, for example, into the RAM 503 via the input/output interface 505 and the bus 504, and executes the program. Accordingly, the above-mentioned series of processes is executed.

The program which is executed by the computer (CPU 501) can be provided by being recorded in the removable recording medium 511 serving as a package medium or the like, for example. Alternatively, the program can be provided via a wired or wireless transmission medium such as a local area network, the internet, or digital satellite broadcasting.

In the computer, when the removable recording medium 511 is attached to the drive 510, the program can be installed into the recording section 508 via the input/output interface 505. Moreover, the program can be received at the communication section 509 via a wired or wireless transmission medium, and be installed into the recording section 508. Alternatively, the program can be preliminarily installed in the ROM 502 and the recording section 508.

It is to be noted that the program which is executed by the computer may be a program for executing the processes in the time-series order explained herein, or may be a program for executing the processes in parallel or at a necessary timing such as a timing when a call is made.

In addition, embodiments of the present technology are not limited to the above-mentioned embodiment, and various changes can be made within the scope of the gist of the present technology.

For example, the present technology can be configured by cloud computing in which one function is shared and cooperatively processed by a plurality of devices over a network.

In addition, the steps having been explained with reference to the above-mentioned flowchart may be executed by one device, or may be cooperatively executed by a plurality of devices.

Moreover, in a case where a plurality of processes are included in one step, the plurality of processes included in the one step may be executed by one device, or may be cooperatively executed by a plurality of devices.

In addition, the present technology can also be configured as follows.

(1)

A data creation method performed by a data creation device, the data creation method including:
a step of, by partially or wholly changing a creation parameter which is obtained by conversion of a source image of a freely-selected face to a numerical value, creating a larger number of input creation parameters than a predetermined number from the predetermined number of the creation parameters of the source images; and
a step of, by creating a face image data item on the basis of a plurality of the input creation parameters, creating a face image dataset including a plurality of the face image data items.
   (2)

The data creation method according to (1), in which
the data creation device creates a plurality of the input creation parameters from one creation parameter by increasing or reducing some or all of a plurality of parameters constituting the creation parameter.
   (3)

The data creation method according to (1) or (2), in which,
by changing a specific parameter constituting the creation parameter, the data creation device creates the input creation parameters.
   (4)

The data creation method according to any one of (1) to (3), in which,
by blending the input creation parameters and the creation parameter of a preset face image prepared in advance, the data creation device creates final input creation parameters.
   (5)

The data creation method according to (4), in which
the preset face image includes an imaginary face image.
   (6)

The data creation method according to (4) or (5), in which
the data creation device performs cleansing on the creation parameters of a plurality of the preset face images, and blends the creation parameters of the preset face images having undergone the cleansing and the input creation parameters.
   (7)

The data creation method according to any one of (1) to (6), in which
the data creation device scrambles the creation parameter of the source image, and creates the input creation parameters on the basis of the scrambled creation parameter.
   (8)

The data creation method according to (7), in which
the data creation device performs the scrambling by adding a random noise to a parameter in a specific layer of a plurality of layers constituting the creation parameter of the source image.
   (9)

The data creation method according to any one of (1) to (8), in which,
by performing face ID/attribute labeling and cleansing on the face image dataset, the data creation device creates a final face image dataset.
   (10)

The data creation method according to (9), in which,
by performing cleansing on the face image dataset, the data creation device creates the final face image dataset that satisfies a predetermined requirement.
   (11)

The data creation method according to (10), in which
the predetermined requirement is the number of the face image data items constituting the face image dataset, a resolution of the face image data items, an attribute to be subjected to labeling, or statistics of attribute values of attributes of the face image data items.
   (12)

The data creation method according to any one of (1) to (11), in which,
by converting the source image to a numerical value, the data creation device creates the creation parameter according to the source image.
   (13)

The data creation method according to any one of (1) to (12), in which
the data creation device creates the face image data items by using a GAN or a VAE according to the input creation parameters.
   (14)

A data creation device including:
a parameter creation section that, by partially or wholly changing a creation parameter which is obtained by conversion of a source image of a freely-selected face to a numerical value, creates a larger number of input creation parameters than a predetermined number from the predetermined number of the creation parameters of the source images; and
a dataset creation section that, by creating a face image data item on the basis of a plurality of the input creation parameters, creates a face image dataset including a plurality of the face image data items.
   (15)

A program for causing a computer to implement a process including steps of:
by partially or wholly changing a creation parameter which is obtained by conversion of a source image of a freely-selected face to a numerical value, creating a larger number of input creation parameters than a predetermined number from the predetermined number of the creation parameters of the source images; and
by creating a face image data item on the basis of a plurality of the input creation parameters, creating a face image dataset including a plurality of the face image data items.

### REFERENCE SIGNS LIST

11: Data creation device
21: Encoder
22: Scrambling section
23: Attribute/ID control section
24: Decoder
25: Annotation section

1. A data creation method performed by a data creation device, the data creation method comprising:
a step of, by partially or wholly changing a creation parameter which is obtained by conversion of a source image of a freely-selected face to a numerical value, creating a larger number of input creation parameters than a predetermined number from the predetermined number of the creation parameters of the source images; and
a step of, by creating a face image data item on a basis of a plurality of the input creation parameters, creating a face image dataset including a plurality of the face image data items.

2. The data creation method according to claim 1, wherein
the data creation device creates a plurality of the input creation parameters from one creation parameter by increasing or reducing some or all of a plurality of parameters constituting the creation parameter.

3. The data creation method according to claim 1, wherein,
by changing a specific parameter constituting the creation parameter, the data creation device creates the input creation parameters.

4. The data creation method according to claim 1, wherein,
by blending the input creation parameters and the creation parameter of a preset face image prepared in advance, the data creation device creates final input creation parameters.

5. The data creation method according to claim 4, wherein
the preset face image includes an imaginary face image.

6. The data creation method according to claim 4, wherein
the data creation device performs cleansing on the creation parameters of a plurality of the preset face images, and blends the creation parameters of the preset face images having undergone the cleansing and the input creation parameters.

7. The data creation method according to claim 1, wherein
the data creation device scrambles the creation parameter of the source image, and creates the input creation parameters on a basis of the scrambled creation parameter.

8. The data creation method according to claim 7, wherein
the data creation device performs the scrambling by adding a random noise to a parameter in a specific layer of a plurality of layers constituting the creation parameter of the source image.

9. The data creation method according to claim 1, wherein,
by performing face ID/attribute labeling and cleansing on the face image dataset, the data creation device creates a final face image dataset.

10. The data creation method according to claim 9, wherein,
by performing cleansing on the face image dataset, the data creation device creates the final face image dataset that satisfies a predetermined requirement.

11. The data creation method according to claim 10, wherein
the predetermined requirement is the number of the face image data items constituting the face image dataset, a resolution of the face image data items, an attribute to be subjected to labeling, or statistics of attribute values of attributes of the face image data items.

12. The data creation method according to claim 1, wherein,
by converting the source image to a numerical value, the data creation device creates the creation parameter according to the source image.

13. The data creation method according to claim 1, wherein
the data creation device creates the face image data items by using a GAN or a VAE according to the input creation parameters.

14. A data creation device comprising:
a parameter creation section that, by partially or wholly changing a creation parameter which is obtained by conversion of a source image of a freely-selected face to a numerical value, creates a larger number of input creation parameters than a predetermined number from the predetermined number of the creation parameters of the source images; and
a dataset creation section that, by creating a face image data item on a basis of a plurality of the input creation parameters, creates a face image dataset including a plurality of the face image data items.

15. A program for causing a computer to implement a process comprising steps of:
by partially or wholly changing a creation parameter which is obtained by conversion of a source image of a freely-selected face to a numerical value, creating a larger number of input creation parameters than a predetermined number from the predetermined number of the creation parameters of the source images; and
by creating a face image data item on a basis of a plurality of the input creation parameters, creating a face image dataset including a plurality of the face image data items.
